(19) United States
(12) Patent Application Publication
(10) Pub. No.: US 2016/0289941 A1
(43) Pub. Date: Oct. 6, 2016

(54) Cleaning apparatus and method of using and applying self-adhesive material for cleaning a surface

(71) Applicant: S.C. JOHNSON & SON, INC., Racine, WI (US)

(72) Inventors: Bryan C. Hale, Gurnee, IL (US); Michael E. Klinkhammer, Dunedin, FL (US)

(73) Assignee: S. C. Johnson & Son, Inc., Racine, WI (US)

(21) Appl. No.: 15/037,261

(22) PCT Filed: Nov. 18, 2014
(86) PCT No.: PCT/US2014/066081

§ 371 Date: May 17, 2016

Related U.S. Application Data
(60) Provisional application No. 61/905,669, filed on Nov. 18, 2013.

(51) Int. Cl. E03D 9/02; B08B 7/00; B08B 9/087; C11D 17/00; B08B 9/093

(52) U.S. Cl. CPC E03D 9/02; C11D 17/0056; B08B 9/093; B08B 9/087; B08B 7/00; E03D 2009/024

(57) ABSTRACT

A cleaning apparatus and a method of using the cleaning apparatus to clean a surface is provided. The cleaning apparatus can include a release material having a first half and a second half. The first half and the second half can be wrapped around a self-adhesive material and can be configured to release the self-adhesive material when the self-adhesive material is applied to a surface. After the self-adhesive material is secured to the surface for a predetermined period, a shear force required to remove the product from the surface may be increased. Packaging may include instructions indicating to a user to wait a predetermined time period prior to using the self-adhesive material as a manual cleaning agent. The predetermined time period prior to using the self-adhesive material as a manual cleaning agent can be approximately 24 hours.

### CROSS REFERENCE TO RELATED APPLICATION

This Application claims priority to U.S. Provisional Patent Application No. 61/905,669 filed Nov. 18, 2013, which is incorporated herein by reference in its entirety.

### FIELD

The present disclosure generally relates to a cleaning apparatus and methods for delivering a self-adhesive material for cleaning a surface. More specifically, applicators and methods are provided for delivery of a self-adhesive, particularly the delivery of a sanitary agent to a surface for cleaning, such as the surface of a toilet.

### BACKGROUND

Agents for cleaning, sanitizing, and deodorizing surfaces of bathroom appliances such as toilets can be in the form of solids, pastes, gels, powders and liquids. Liquid formulations delivered in squeeze bottles allow for periodic cleaning of the appliance and typically require a consumer to reapply the sanitary agent each time the appliance is to be cleaned. Other products that demand less time by the consumer allow for automatic or continuous cleaning of the appliance. For example, automatic or continuous cleaning is afforded by providing sanitary agents in the form of solid blocks or by suspending the sanitary agent in baskets that hang from the appliance.

Other agents such as self-adhesive materials adhere to substrates such as surfaces of bathroom appliances. For example, self-adhesive sanitary agents allow for direct application of the sanitary agent to a surface, and thus provide automatic or continuous cleaning of an appliance while overcoming the drawbacks of previous forms.

### SUMMARY

This Summary provides an introduction to some general concepts relating to this disclosure in a simplified form that are further described below in the Detailed Description. This Summary is not intended to identify key features or essential features of the disclosure.

Aspects of the disclosure herein relate to a cleaning apparatus, a self-adhesive material for cleaning a surface, an applicator for the self-adhesive material, a method of using the cleaning apparatus, applicator, and self-adhesive material, and instructing the user on a cleaning method.

In one example, the cleaning apparatus can include an applicator, which includes a release material having a first half and a second half. The first half and the second can be wrapped around a self-adhesive material and can be configured to release the self-adhesive material when the self-adhesive material is applied to a surface. After the self-adhesive material is secured to the surface for a predetermined period, the self-adhesive material can cure to the surface, and a shear force required to remove the product from the surface may be increased.

In another example, a cleaning method can include applying a self-adhesive material to a surface using a release material, allowing for the self-adhesive material to cure to the surface for a predetermined time period, and brushing the surface after the predetermined time period.

In another example, product packaging may include instructions indicating to a user to wait a predetermined time period prior to using the self-adhesive material as a manual cleaning agent. For example, the predetermined time period prior to using the self-adhesive material as a manual cleaning agent can be approximately 24 hours.

### BRIEF DESCRIPTION OF THE DRAWINGS

The foregoing Summary, as well as the following Detailed Description, will be better understood when considered in conjunction with the accompanying drawings in which like reference numerals refer to the same or similar elements in all of the various views in which that reference number appears.

FIG. 1A illustrates an applicator for a self-adhesive material and a method of applying the self-adhesive material to a surface.

FIG. 1B illustrates an alternative view of the applicator for the self-adhesive material and the method of applying the self-adhesive material to the surface.

FIG. 1C illustrates an alternative view of the applicator for the self-adhesive material and the method of applying the self-adhesive material to the surface.

FIG. 1D illustrates the self-adhesive material applied to the surface and method of cleaning the surface.

FIG. 2 illustrates a pressure mapping showing the forces applied to a surface when the self-adhesive material is applied.

FIG. 3 is a graphical representation of the application force of the applicator verses the shear force required to remove the self-adhesive material from the surface and the effect of the self-adhesive material curing for 24 hours on the surface.

FIG. 4 illustrates the same data of FIG. 3 and the average amount consumer brushing force to show the likelihood that the self-adhesive material will be removed from the surface.

### DETAILED DESCRIPTION

In the following description of various example structures in accordance with the disclosure, reference is made to the accompanying drawings, which form a part hereof, and in which are shown by way of illustration of various structures in accordance with this disclosure. Additionally, it is to be understood that other specific arrangements of parts and structures may be utilized, and structural and functional modifications may be made without departing from the scope of the present disclosure.

Also, while the terms “top” and “bottom” and the like may be used in this specification to describe various example features and elements of the disclosure, these terms are used herein as a matter of convenience, e.g., based on the example orientations shown in the figures and/or the orientations in typical use. Nothing in this specification should be construed as requiring a specific three dimensional or spatial orientation of structures in order to fall within the scope of the present disclosure.

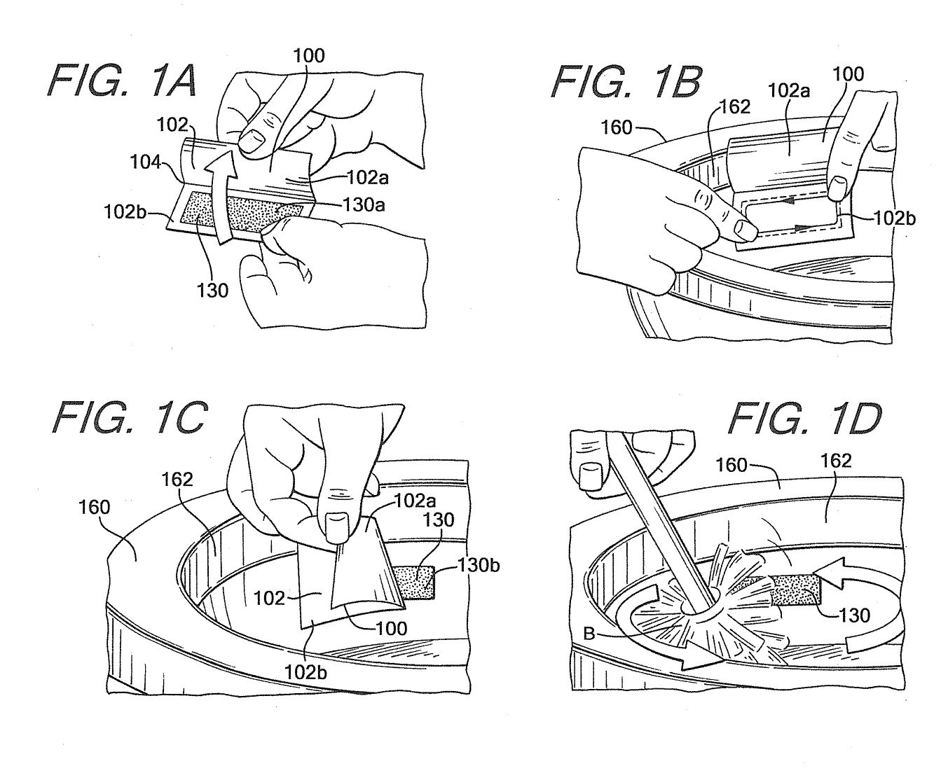

FIGS. 1A-1C depict an exemplary applicator 100 for applying a self-adhesive material 130 to a surface desired to be cleaned. FIG. 1A shows an applicator 100 in a first unfolded position. As shown in FIG. 1A, the applicator 100 can be formed of a release material 102 formed of a single sheet of material to hold the self-adhesive material 130. The self-adhesive material 130 can be configured to continuously clean a surface by releasing cleaning or fragrance components when exposed to water. As shown in FIGS. 1A and 1C, the self-adhesive material 130 can define a first face 130a and a second face 130b, which are both configured to adhere to the surface desired to be cleaned and the release material 102.

The release material 102 is configured to release the self-adhesive material 130 on a desired surface to be sanitized. In particular, the release material 102 can be formed with a crease 104 for folding the release material 102 into a first half 102a and a second half 102b around portions of the self-adhesive material 130. In particular, the first half 102a and the second half 102b of the release material 102 can be wrapped around the self-adhesive material 130 such that the first face 130a of the self-adhesive material 130 is covered by and adheres to the first half 102a of the release material 102, and the second face 130b of the self-adhesive material 130 is covered by and adheres to the second half 102b of the release material 102. An edge of the self-adhesive material 130 can also be covered by the release material 102, and in certain examples, the release material 102 can adhere to the edge of the self-adhesive material 130. In one example, the remaining three edges can remain uncovered.

Before use, the self-adhesive material 130 can be secured or adhered to inner surfaces of the first half 102a and the second half 102b of the release material 102. The inner surfaces of the first half 102a and the second half 102b of the release material 102 surround and together wrap substantially around the self-adhesive material 130 to receive and contain the self-adhesive material 130. Thus, the release material 102 can cover the self-adhesive material 130 prior to applying the self-adhesive material 130 to a surface and protects the self-adhesive material 130 from exposure to the elements prior to application.

In one example, the release material 102 can be formed of a wax paper and can be formed opaque, translucent, or transparent. The use of a single sheet release material 102 can provide a lower cost applicator, can simplify the manufacturing process of the applicator, and may provide an improved operational equipment effectiveness. The release material 102 can be formed of a paper substrate that is configured to break up in water rapidly in case the release material 102 is not fully removed from the self-adhesive material 130 during application to the surface. The release material 102 can also be formed of biodegradable or other environmentally compatible materials. Other suitable materials are also contemplated, such as a silicone coated paper or other low-friction materials that will release easily from the self-adhesive material. In addition, the release material 102 can be formed to be water soluble to dissolve when exposed to water, such that it can be left on the self-adhesive material after the self-adhesive material is applied to the surface.

Additionally, although not shown, the applicator 100 can be stored initially in a pouch or carton to properly seal the self-adhesive material 130 prior to use so as to not spoil its contents before delivery. The pouch or carton can be formed from foils, plastic films, cardboard-like material with or without coatings, or combinations thereof to provide a barrier against moisture and odor or fragrance.

In one example, the self-adhesive material 130 can attach directly to a wall of a toilet bowl or urinal, either above or below the water-line and in the stream of flush water, by pressing the self-adhesive material 130 against the wall. In certain examples, the self-adhesive material 130 will not require any additional device, or other mechanical means, to maintain and/or support and/or otherwise suspend the self-adhesive material 130 in a fixed place, particularly in light of natural gravitational forces or manual cleaning forces, e.g., brushing forces, acting on the self-adhesive material 130. In one example, the adhesive properties of the self-adhesive material 130 and the release material 102 are controlled such that adhesive force between the self-adhesive material 130 and the release material 102 is less than adhesive force between the self-adhesive material 130 and the desired surface. In this way, the release material 102 readily releases or is configured to peel away from the self-adhesive material 130 when the self-adhesive material 130 is adhered to a surface such as the inside surface of a toilet bowl.

The self-adhesive material 130 can be a toilet bowl freshening and cleaning product. The self-adhesive material 130 can include any gel, paste, wax, solid, or the like and can have a dough or putty-like consistency that may adhere to the surface or substrate. The self-adhesive material 130 can include active beads to increase the cleaning efficiency of the self-adhesive material 130, or the self-adhesive material 130 can include inactive beads, e.g., the beads can provide the desired appearance of the self-adhesive material 130 to the user. Example formulations are discussed in more detail below.

The self-adhesive material 130 can be formed into any desired shape, e.g., square or rectangular shape. A rectangular shape may have certain advantages. For example, a rectangular shape may be more resilient to manual cleaning or when a brush is applied to the self-adhesive material 130 and may provide a better level of cleaning and more consistent results during use. The shape of the self-adhesive material 130 can also be selected based on desired ornamental features to entice a user to purchase the product. Also the self-adhesive material 130 can include a certain degree of flexibility to accommodate for curvature of the desired cleaning surface.

In certain alternative examples, it is contemplated that the release material can be placed on only a single face or surface of the self-adhesive material or can be formed of multiple pieces of material. Moreover, the multiple pieces of the release material can cover the entire self-adhesive material or a singular sheet of release material can cover the entire self-adhesive material. In addition, a single face or surface of the self-adhesive material may be configured to adhere to the surface by altering the configuration of the self-adhesive material formula or the release material. Additionally, the formulation of the self-adhesive material can be altered such that the user can handle at least portions of the self-adhesive material directly. Thus, the release material can be omitted entirely, and the self-adhesive material can be stored directly in a pouch or carton. Moreover, gripping elements can be in-molded or added to the self-adhesive material to assist the user in grasping the self-adhesive material and applying the self-adhesive material to a surface.

It was observed that the adhesion properties of the self-adhesive material 130 can be improved by up to 300% with 1 day of normal toilet use without brushing or scrubbing. During this period, the water in the toilet dissolves the self-adhesive material 130 and fills in open spaces between the self-adhesive material 130 and toilet surface. During low to no use intervals, such as overnight, the filled area dries and creates a stronger bond to the surface. Thus, the one-day length of curing time may significantly improve the adhesion properties of the self-adhesive material 130 to the surface. Therefore, packaging inserts may indicate to the user to wait a predetermined time period, e.g., one day prior to scrubbing to help the consumer achieve the desired results.

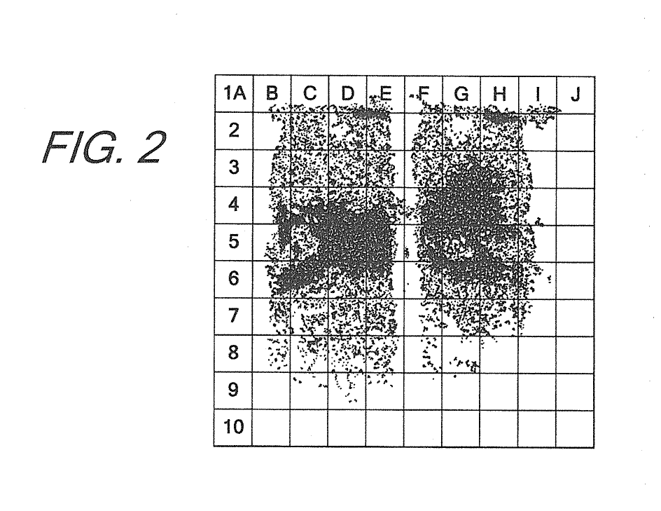

Using a pressure sensitive film, a study was able to determine the actual ranges of force consumers apply to the applicator 100 and self-adhesive material 130. In the study, a film was taped inside a toilet bowl so all data was reflective of what the actual product would yield. It was observed that the user on average applies about 17 to 21 lbs. of force on the release material 102. FIG. 2 shows a pressure diagram of the data observed for the application of the release material 102 to a surface. The darker and solid areas indicate areas where the pressure applied to the surface is the greatest. As shown in FIG. 2, the user applies a consistent amount of pressure across the surface area of the self-adhesive material 130, which allows for the energy applied to the applicator 100 to be fully transferred to the self-adhesive material 130 to the surface.

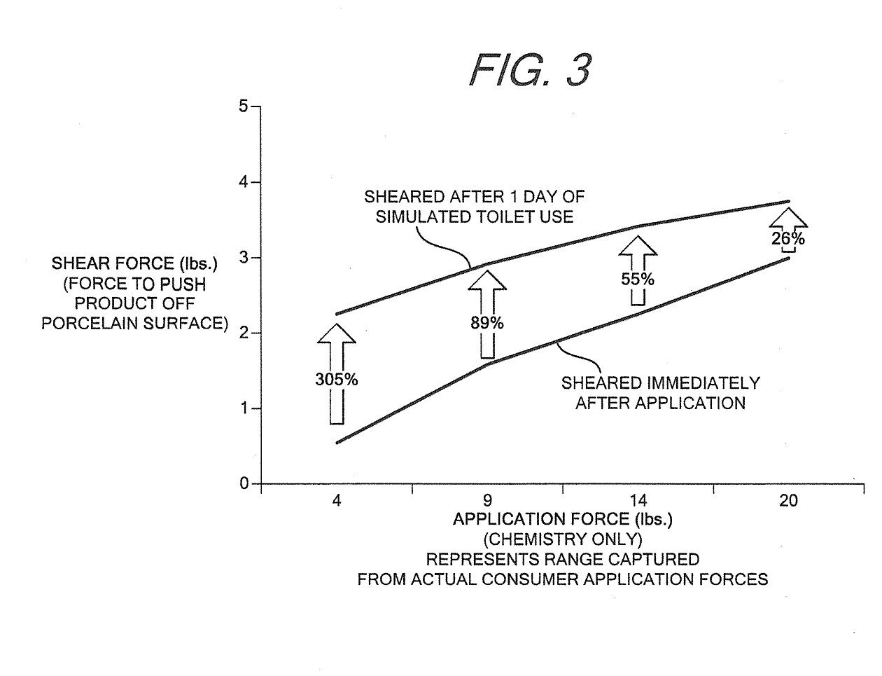

FIG. 3 shows the results of a study conducted to determine what impacts time and application force may have to the adhesion of the self-adhesive material 130 to a surface. In particular, the study reviewed whether waiting a day after the application of the self-adhesive material 130 with consistent flushing had any impact on the adhesion performance of the self-adhesive material 130. The study reviewed multiple factors, including shape, thickness, hardness and humidity conditions. The study focused on paste self-adhesive material 130. However, any other suitable consistency is contemplated, e.g., gel, solid, etc.

During the study the self-adhesive material 130 was applied to ceramic tiles at various forces using precision equipment. Shear force data was collected at two different times: i) immediately after application and ii) 24 hours after application. The samples tested after 24 hours were subjected to 12 hours of normal flushing conditions (to simulate daytime conditions), followed by 12 hours of no flushing (to simulate nighttime conditions). To simulate normal flushing conditions during the first 12 hour period, the tiles with the samples were placed in a dunk tank that was filled up with water and then immediately drained for a total of 6 times every 2 hours. The testing was done under ambient conditions.

As shown in FIG. 3 waiting 24 hours or 1 day after the application of the self-adhesive material 130 to the surface increases the amount of shear force or the force required to push or pull the self-adhesive material 130 off of the surface. Specifically the lower line shows the shear forces measured for removing the product just after the application of the self-adhesive material 130 to the surface, and the upper line shows the amount of force measured to remove the self-adhesive material 130 from the surface 24 hours or 1 day after the application of the self-adhesive material 130 to the surface.

It was also observed that the greater amount of force applied to the self-adhesive material 130 initially resulted in a higher amount of force required to remove the self-adhesive material 130 both right after application and after the 24 hour-time period. However, the greatest percentage, 306%, of increase of force required to remove the self-adhesive material 130 from the surface was observed after 24 hours when four lbs. of force was applied to the self-adhesive material 130 onto the toilet initially. The lowest percentage, 26%, of increase of force required to remove the self-adhesive material 130 from the surface was observed after 24 hours when about 20 lbs. of force was applied to the self-adhesive material 130 onto the toilet initially.

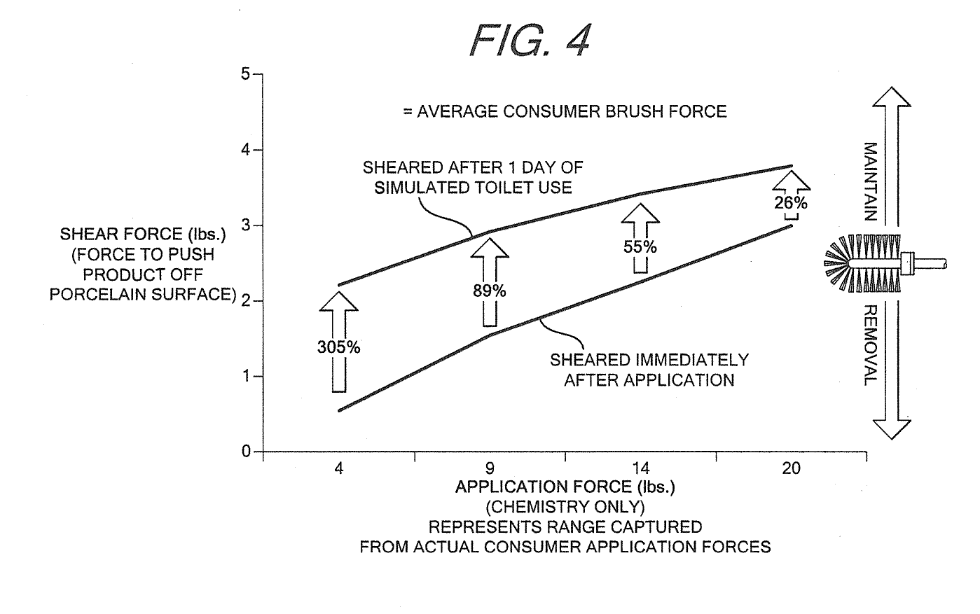

In another study, the levels of forces were measured from a toilet brush onto the self-adhesive material 130 during cleaning. In this test, a toilet brush was provided with a series of digital measurement sensors. The average scrub force of a typical user was 2.5 lbs. Therefore, if the shear force required to remove the self-adhesive material 130 is less than 2.5 lbs. then the self-adhesive material 130 may be dislodged when a brush is applied to the self-adhesive material 130. Taking the previous data points from FIG. 3, it is shown in FIG. 4 that 1 day of toilet use prior to brushing improves the brushing result in that brushing is less likely to remove the self-adhesive material 130. In particular, where the shear force was increased to greater than 2.5 lbs., the self-adhesive material 130 remained on the surface during brushing of the self-adhesive material 130.

FIG. 4, however, is merely an example study of a suitable operational range of the self-adhesive material 130. The operational range is subject to the particular design of the self-adhesive material (e.g. size, material, shape, etc.) and application method. Thus, other force variations are contemplated to fall within the scope of the disclosure. For example, the threshold shear force for maintaining the self-adhesive material 130 on the surface could be between 1.5 lbs. and 3 lbs. In one example, a shear force of the self-adhesive material on the surface above 1.5 lbs. maintains the self-adhesive material 130 on the surface during brushing of the self-adhesive material 130.

FIGS. 1A-1D demonstrate methods of applying the self-adhesive material 130 to a desired surface for sanitizing with the applicator 100. In one example, the user can be provided with instructions that can be included with the applicator 100 for using the product in accordance with one or more steps of the methods described herein. In the example depicted in FIGS. 1A-1D, the self-adhesive material 130 can be formed of a gel, paste, or other suitable consistency.

First, the applicator 100 can be removed from an outer covering such as a pouch by tearing open the pouch, and the release material 102 is initially wrapped around at least a portion of the self-adhesive material 130 forming a wrapped self-adhesive material 130. As shown in FIG. 1A, the user then can peel back a portion of the release material 102, e.g. either the first half 102a or the second half 102b of the release material 102, to expose the self-adhesive material 130 first face 130a or second face 130b.

As shown in FIG. 1B, the self-adhesive material 130 can be applied to the surface by pressing on the outer surface of the release material half containing the self-adhesive material 130 to press the release material 102 and the self-adhesive material 130 against the surface. In one example, as shown in FIG. 1B, the self-adhesive material 130 can be applied to the inside of a toilet bowl. In particular, the self-adhesive material 130 can be applied just below a rim of the toilet bowl, where water flows when the toilet is flushed above the water line of the toilet bowl. In particular, the user can place the self-adhesive material 130 slightly below the rim 162 of the toilet 160 such that the water can come into contact with the self-adhesive material 130 when the toilet is flushed.

The user can be advised to attach the self-adhesive material 130 securely to the toilet surface by pressing firmly along the entire border or perimeter of the self-adhesive material 130 on the entire release material half containing the adhesive material 130. This action provides an even and consistent application of force as graphically illustrated by FIG. 2. For certain self-adhesive material 130 formulations, it may be desired that the self-adhesive material 130 be applied to a dry toilet bowl surface. However, certain self-adhesive material 130 formulations may be suitable for either dry or wet applications.

As shown in FIG. 1C, the release material 102 can then be pulled away from the self-adhesive material 130 by grasping the first half 102a of the release material 102 to pull the self-adhesive material 102 away from the release material 102 such that the self-adhesive material 130 remains adhered to the desired surface. The release material 102 can then be discarded and the formulation (cleaning components) of the self-adhesive material 130 can be activated by flushing the toilet and exposing the self-adhesive material 130 to water. In other examples, however, the release material can remain on the self-adhesive material 130 and can dissolve upon normal use of the toilet. The self-adhesive material 130 can be configured to both clean the surface and release a fragrance with each flush.

Installed in this manner, the self-adhesive material 130 can function as a continuous toilet bowl cleaner such that after each flush of the toilet water comes into contact with the self-adhesive material 130 and the cleaning components are dispersed about the toilet surface. Thus, cleaning takes place without further efforts from the user.

The strength of the bond between the self-adhesive material 130 and the toilet 160 increases over time, and the user can also be instructed to wait a certain amount of time before applying a brush to the surface. After a predetermined period of time (e.g., hours, days, weeks, etc.), during which a number of flushes have been made, the self-adhesive material is allowed to better cure on the surface, and a user can also use the remaining portion of the self-adhesive material 130 as a manual toilet bowl cleaner.

For example, as shown in FIG. 1D, after the predetermined time period, the toilet bowl can be cleaned with a brush B when desired. In particular, the brush B can be used to take a small piece of gel from one end of the self-adhesive material 130 to release the cleaning agents and scrub the toilet bowl as usual. In one example, as shown in FIG. 1D, the user can brush the remaining portions of the self-adhesive material 130 to conduct a manual cleaning of the toilet surface. It is also contemplated that other cleaning implements could be used in conjunction with the self-adhesive material, e.g. fabrics, cloths, sponges, scrappers, scrubbers, etc. In this way the self-adhesive material can be marketed as both a continuous and manual cleaning agent.

The packaging for the applicator 100 can include instructions that instruct a user to peel back either the first half 102a or the second half 102b of the release material 102 from one of the first face 130a or the second face 130b of the self-adhesive material 102 to expose either the first face 130a or the second face 130b of the self-adhesive material 130, to apply the self-adhesive material 102 to the surface by pressing one of the first half 102a or the second half 102b of the release material 102 and the self-adhesive material 130 against the surface. The instructions may also indicate to the user to wait a predetermined time period, e.g. approximately 24 hours, after application of the self-adhesive material 130 before brushing or scrubbing the self-adhesive material 130 and using the self-adhesive material 130 as a manual toilet bowl cleaner, e.g. “for best results wait 1 day prior to scrubbing” to the use instructions. However, other time periods are contemplated depending on the particular self-adhesive material properties, e.g. size, shape, composition, etc. This predetermined period can define a length of time that increases the shear force required to remove the self-adhesive material 130 from the surface such that the self-adhesive material 130 will remain adhered to the surface during normal cleaning. Although the applicator 100 and self-adhesive material 130 in this example are used to clean a toilet, other applications and uses of the applicator 100 and self-adhesive material 130 are contemplated such as showers, baths, sinks, etc.

In certain examples, the self-adhesive material includes 25% to 99% of a solid surfactant, and 1% to 25% of a liquid component, wherein all percentages are percent by weight of the total composition of the self-adhesive material. The liquid component may selected from water, surfactants, glycerin, fragrances, colorants, alcohols, binders, lime-scale removing agents, hydrotropes, solvents, chelating agents, dispersing agents, and mixtures thereof. The self-adhesive material may further include a filler. In certain examples, the self-adhesive material is a paste or has a paste-like consistency. In some examples, the self-adhesive material contains proportions of the above-identified ingredients such that the final material is solid and has a mass that has a “sticky” consistency. In certain embodiments, the self-adhesive material does not flow, i.e., the material is not viscous.

The ratio of the solid surfactant and the liquid component may depend on the liquid and its penetration (liquid absorption into the solid) and the solubility of the solid surfactant in the liquid(s). For a liquid fragrance, it may desirable to absorb more than solubilize. The self-adhesive material may include one or more solid surfactants, and optionally one or more liquid surfactants. The surfactants may be anionic, nonionic, cationic and/or amphoteric depending on the cleaning properties desired. The self-adhesive material may include about 25-99 wt. % of solid surfactant, and in some examples include about 40-95 wt. % of solid surfactant, and in various examples about 50-90 wt. % of solid surfactant. In some embodiments, the solid surfactant provides adherence to a surface. For greater foaming, a higher solid surfactant level may be employed, such as at least 70%. For increased longevity, lower solid surfactant levels, such as 40% and less, may be employed.

If present, the liquid surfactant may be included in the self-adhesive material at levels up to 25 wt. %, and in some examples up to 15 wt. %, and in various examples up to 10 wt. %. In some examples, liquid surfactants increase solubility of the material, which increases foam and releases more fragrance per flush. (All weight percentages are percent by weight of the total self-adhesive material composition.) Suitable anionic surfactants include alkali metal salts of alkyl, alkenyl and alkylaryl sulfates and sulfonates. Some such anionic surfactants have the general formula RSO₄M or RSO₃M, where R may be an alkyl or alkenyl group of about 8 to about 20 carbon atoms, or an alkylaryl group, the alkyl portion of which may be a straight-chain or branched-chain alkyl group of about 9 to about 15 carbon atoms, the aryl portion of which may be phenyl or a derivative thereof, and M may be an alkali metal (e.g. sodium, potassium or lithium). M may also be a nitrogen derivative (e.g. amino or ammonium).

In certain examples, the solid anionic surfactants include sodium lauryl sulfate, sodium lauryl ether sulfate and sodium dodecyl benzene sulfonate. In some examples, the solid anionic surfactant is a sodium dodecyl benzene sulfonate sold commercially as “UFARYL” DL85 by Unger Fabrikker, Fredistad, Norway. Another example solid anionic surfactant is powdered sodium lauryl sulfate sold as Stepanol® ME-Dry by Stepan. Another example solid anionic surfactant is powdered sodium (C₁₄-C₁₆) olefin sulfonate sold as Bio-Terge® AS-90B by Stepan. Other example anionic surfactants are sulfosuccinates. Useful liquid anionic surfactants can also be added; including but not limited to sodium lauryl ether sulfate, sodium lauryl sulfate, sodium alkyl aryl sulfonate. In certain embodiments, water may be added, although in some embodiments no water is added. Example nonionic surfactants include alkylpolyglycosides, such as those available under the tradename GLUCOPON from Henkel, Cincinnati, Ohio, USA.

The alkylpolyglycosides may have the following formula: RO—(R′O)ₓ—Zₙ, where R is a monovalent alkyl radical containing 8 to 20 carbon atoms (the alkyl group may be straight or branched, saturated or unsaturated), O is an oxygen atom, R′ is a divalent alkyl radical containing 2 to 4 carbon atoms, for example ethylene or propylene, x is a number having an average value of 0 to 12, Z is a reducing saccharide moiety containing 5 or 6 carbon atoms, for example a glucose, galactose, glucosyl, or galactosyl residue, and n is a number having an average value of about 1 to 10.

Other example nonionic surfactants include alcohol ethoxylates such as those available under the trade name LUTENSOL from BASF, Ludwigshafen, Germany. These surfactants have the general formula C₁₃H₂₅/C₁₅H₂₇—(OC₂H₄)n-OH (the alkyl group is a mixture of C₁₃/C₁₅). Other example surfactants include LUTENSOL AO3 (n=3), AO8 (n=8), and AO10 (n=10). Other alcohol ethoxylates include secondary alkanols condensed with (OC₂H₄) such as Tergitol 15-S-12, a C₁₁-C₁₅ secondary alkanol condensed with 12 (OC₂H₄) available from Dow Surfactants. Another example nonionic surfactant is polyoxyethylene (4) lauryl ether. Amine oxides are also suitable. An example solid nonionic surfactant is powdered tallow fatty alcohol ethoxylate with 50 moles of EO sold as Genapol T-500P by Clariant. In some examples, the solid nonionic surfactants may help to control dissolution rates in water and also help adhesion to a surface.

Useful cationic surfactants may include, for example, primary amine salts, diamine salts, and quaternary ammonium salts. Useful amphoteric surfactants may include alkyl aminopropionic acids, alkyl iminopropionic acids, imidazoline carboxylates, alkylbetaines, sulfobetaines, and sultaines. In certain examples, inert filler can be added to the self-adhesive material, for example to achieve adequate density and to keep costs to the minimum. If present, the filler may be included in the self-adhesive material at levels up to 60 wt. %, in some examples up to 40 wt. %, and in still others up to 25 wt. %. The filler may comprise inert salts, such as water-soluble inorganic or organic salts (or mixtures of such salts). Examples include various alkali metal and/or alkaline earth metal sulfates, chlorides, borates, and citrates. Specific inert salts include sodium sulfate, calcium sulfate, sodium chloride, potassium sulfate, sodium carbonate, lithium chloride, tripotassium phosphate, sodium borate, potassium fluoride, sodium bicarbonate, calcium chloride, magnesium chloride, sodium citrate, magnesium sulfate and sodium fluoride.

The self-adhesive material may include an alcohol. If present, the alcohol may be included in the self-adhesive material at levels up to 25 wt. %, in certain embodiments up to 15 wt. %, and in various examples up to 10 wt. %. One example alcohol is Neodol 23 marketed by Shell Oil Company. It is a mixture of C₁₂ and C₁₃ linear primary alcohols. As alternatives, it is believed that any linear (unbranched) primary fatty alcohol of less than C₂₁ and greater than C₈ (and mixtures thereof will also be suitable. Examples are 1-dodecanol; EPAL-16 (by Ethyl Corporation) which is a mixture of decanol, dodecanol, tetradecanol, and octadecanol; and ALFOL 1214 (by Vista Chemical Co.) which is a mixture of dodecanol and tetradecanol. Another example alcohol is glycerin. In certain examples, the alcohol may help control solution rates in water and help adhesion to a surface. A fragrance can also be added, depending on the type of aroma that is to be imparted. If present, the fragrance may be included in some example of the self-adhesive material at levels up to 25 wt. %, in certain examples to 15 wt. %, and in still other examples up to 10 wt. %. For instance, pine, citrus and potpourri scents can be employed. In some examples, any fragrance oils are essentially insoluble in water. Fragrance oils have the added advantage of, in some examples, facilitating extrusion of the self-adhesive materials during manufacture.

A colorant is also optionally included in the self-adhesive material. If present, in some examples the colorant may be included in the self-adhesive material at levels up to 10 wt. %. The choice of the colorant will largely depend on the color desired for the water into which the self-adhesive material composition is to be dispensed. A binder may be used in the self-adhesive material to help maintain self-adhesive material integrity. If present, in some examples the binder may be included in the self-adhesive material at levels up to 25 wt. %, in certain examples up to 15 wt. %, and in still other examples up to 10 wt. %. In some examples the binder comprises the hydrated cellulose materials, such as hydroxy alkyl cellulose (especially hydroxy ethyl cellulose or hydroxy propyl cellulose). Gum binders may also be used. Examples are guar, xanthan, tragacanth, carrageenan, karaya, or algin. The self-adhesive material may also include a chlorine releasing agent. If present, in some example the chlorine releasing agent is included in the self-adhesive material at levels up to 40 wt. %, in others up to 25 wt. %, and in still others up to 10 wt. %. Non-limiting examples of a chlorine releasing agent include chloroisocyanuric acids (trichloroisocyanuric acid and dichloroisocyanuric acid), chloroisocyanurates, hypochlorites, chlorosuccinimides, chloramine T (sodium para-toluene sulfochlorine), and halogenated hydantoins (e.g., chlorodimethyl hydantoins).

A lime-scale removing agent may also be present in the self-adhesive material. If present, in some examples the lime-scale removing agent is included in the self-adhesive material at levels up to 40 wt. %, in others up to 15 wt. %, and in still others up to 10 wt. %. Example lime-scale removing agents include, but are not limited to, organic and inorganic acids such as citric acid or sulfamic acid. A hydrotrope may also be present in the self-adhesive material to assist in blending of surfactants and other liquids. If present, in some examples the hydrotrope is included in the self-adhesive material at levels up to 25 wt. %, in various examples up to 15 wt. %, and in still other examples up to 10 wt. %.

Example anionic hydrotropes are alkali metal salts of aromatic sulfonates. An example hydrotrope is sodium xylene sulfonate such as “Stepanate SXS” available from Stepan Chemicals. Other exemplary hydrotropes include sodium butyl monoglycol sulfate, sodium toluene sulfonate and sodium cumene sulfonate.

A solvent may also be present in the self-adhesive material to assist in blending of surfactants and other liquids. If present, in some examples the solvent is included in the self-adhesive material at levels up to 25 wt. %, in various examples up to 15 wt. %, and in still other examples up to 10 wt. %. Example solvents include aliphatic alcohols of up to 8 carbon atoms; alkylene glycols of up to 6 carbon atoms; polyalkylene glycols having up to 6 carbon atoms per alkylene group; mono- or dialkyl ethers of alkylene glycols or polyalkylene glycols having up to 6 carbon atoms per glycol group and up to 6 carbon atoms in each alkyl group; and mono- or diesters of alkylene glycols orpolyalkylene glycols having up to 6 carbon atoms per glycol group and up to 6 carbon atoms in each ester group. Specific examples include t-butanol, t-pentyl alcohol; 2,3-dimethyl-2-butanol, benzyl alcohol or 2-phenyl ethanol, ethylene glycol, propylene glycol, dipropylene glycol, propylene glycol mono-n-butyl ether, dipropylene glycol mono-n-butyl ether, propylene glycol mono-n-propyl ether, dipropylene glycol mono-n-propyl ether, diethylene glycol mono-n-butyl ether, diethylene glycol monomethyl ether, dipropylene glycol monomethyl ether, triethylene glycol, propylene glycol monoacetate, glycerin, ethanol, isopropanol, and dipropylene glycol monoacetate. In certain embodiments, the solvent is dipropylene glycol.

A chelating agent may also be present in the self-adhesive material. If present, in some examples the chelating agent is included in the self-adhesive material at levels up to 25 wt. %, in various examples up to 15 wt. %, and in still other examples up to 10 wt. %. Example chelating agents include ethylenediaminetetraacetic acid (EDTA), trisodium nitrilotriacetate, sodium tripolyphosphate, acrylics, maleic anhydride acrylic copolymers, gluconates, sorbitols, triazoles, phosphonates, and salts of the foregoing. The self-adhesive material may include a dispersing agent such as a polymer. In certain embodiments, the dispersing agent may be selected from the group consisting of a polyacrylic acid and alkali metal salts of polyacrylic acid. If present, in certain examples the dispersing agent is included in the self-adhesive material at levels up to 25 wt. %, in other examples up to 15 wt. %, and in various embodiments up to 10 wt. %. In some embodiments, the polymer is homopolymer sodium polyacrylate. One example version is sold by Rohm & Haas Co. as Acusol 445 ND with a molecular weight of 4,500. Other example polymers include potassium polyacrylate and polyacrylic acid itself.

Other additives that can be included in the self-adhesive material are other cleaning agents (e.g. borax) and/or preservatives (e.g. Dow Chemical's Dowicil® 75). One example material includes: (i) 39-86% (in some examples, 85%) Ufaryl DL 85CJ (solid sodium dodecyl benzene sulfonate 85%), (ii) 0-8% (in some examples, 8%) Glucopon 425N (nonionic surfactant: an alkylpolyglucoside) surfactant with an alkyl group containing from 8 to 16 carbon atoms and having an average degree of polymerization of 1.6, (iii) 0-6% glycerine 99% (in some examples, 2%), (iv) 0-50% sodium sulfate (in some examples, 0%), and (v) 5-8% fragrance (in some examples, 5%). Another example material includes: (i) about 35 wt. % powdered nonionic fatty alcohol ethoxylate surfactant; (ii) about 20 wt. % powdered anionic sodium Lauryl sulfate surfactant; (iii) about 5 wt. % liquid nonionic alcohol ethoxylate surfactant; (iv) about 39 wt. % citric acid; and (v) about 1 wt. % fragrance.

Yet another example material includes: (i) about 65 wt. % of Ufaryl DL85CJ solid anionic alkyl aryl sulfonate; (ii) about 0.0020 wt % of dye; (iii) about 8.5000 wt % Glucopon 425N nonionic, alkyl polyglycoside; (iv) about 0.5000 wt % glycerine; (v) about 19.9980 wt % sodium sulfate; and (vi) about 6.0000 wt % fragrance. Still another example material includes: (i) about 65 wt. % of solid anionic sodium Lauryl sulfate; (ii) about 0.0020 wt % of dye; (iii) about 8.5000 wt % Glucopon 425N nonionic, alkyl polyglycoside; (iv) about 0.5000 wt % glycerine; (v) about 19.9980 wt % sodium sulfate; and (vi) about 6.0000 wt % fragrance.

Still another example material includes: (i) about 60 wt. % of Ufaryl 85CJ solid anionic alkyl aryl sulfonate; (ii) about 8.5000 wt. % Glucopon 425N nonionic, (iii) about 17.9970 wt. % sodium sulfate; (iv) about 5.0000 wt. % calcium carbonate, (v) about 0.0030 wt. % of dye; (vi) about 5.0000 wt. % fragrance; (viii) about 1.000 wt. % of Mirapol Surf-500; (ix) about 0.5000 wt. % of Jojoba Beads 16/20; and (x) about 2.000 wt. % Aveka Beads. Yet another example material includes: (i) about 60 wt. % of Ufaryl 85CJ solid anionic alkyl aryl sulfonate; (ii) about 8.5000 wt. % Glucopon 425N nonionic, (iii) about 17.9998 wt. % sodium sulfate; (iv) about 5.0000 wt. % calcium carbonate, (v) about 0.0020 wt % of dye; (vi) about 5.0000 wt. % fragrance; (viii) about 1.000 wt. % of Mirapol Surf-500; (ix) about 0.5000 wt. % of Jojoba Beads 16/20; and (x) about 2.000 wt. % Aveka beads.

Another example material includes: (i) about 60-65 wt. % of Ufaryl 85CJ solid anionic alkyl aryl sulfonate; (ii) about 9.5000-10.0000 wt. % Glucopon 425; (iii) about 17.9800-25.2800 wt. % sodium sulfate; (iv) about 0.0000-5.000 wt. % glycerine, (v) about 0.0200 wt. % of Bitrex Solution 25% (in Propylene Glycol); and (vi) about 5.0000-7.0000 wt. % fragrance. Yet another example material includes: (i) about 60-65 wt. % of Ufaryl 85CJ solid anionic alkyl aryl sulfonate; (ii) about 8.7000-9.0000 wt. % Glucopon 425; (iii) about 17.9990-25.4000 wt. % sodium sulfate; (iv) about 5.0000-7.0000 wt. % fragrance; (v) about 1.000 wt. % Mirapol Surf S-500 polymer; and (vi) about 0.0010-0.0015 wt. % of one or more dyes (total).

Still another example includes: (i) about 43.149-43.649 wt. % of deionized waterl (ii) about 15.000 wt. % Sodium Lauryl Ether Sulfate (2EO, 70%); (iii) about 12.000-15.000 wt. % Imbentin AG/618 Alkoxylate; (iv) about 12.000-15.000 wt. % Imbentin AG/168S/300 SP Alkoxylate (v) about 5.000 wt. % glycerine; (vi) about 5.000 wt. % fragrance; (vii) about 1.000 wt. % Mirapol Surf S-500 polymer; (viii) about 2.200 wt. % white mineral oil; (ix) about 1.000-1.500 wt. % Neodol 23 alcohol; (x) about 0.00002-0.0010 wt. % dye; and (xi) about 0.150 wt. % Glycacil SG preservative.

Another example material includes: (i) about 60.00 wt. % of Ufaryl 85CJ solid anionic alkyl aryl sulfonate; (ii) about 7.0000-8.4000 wt. % Glucopon 425N nonionic, (iii) about 18.5800-19.9800 wt. % sodium sulfate; (iv) about 5.0000 wt. % calcium carbonate, (v) about 0.0200 wt. % of Bitrex Solution 25% (in Propylene Glycol); (vi) about 5.0000 wt. % fragrance; (vii) about 1.000 wt. % of Mirapol Surf-500; and (viii) about 2.000 wt. % Aveka Beads.

In certain other examples, (i) about 35.000 wt. % of Ufaryl 85CJ solid anionic alkyl aryl sulfonate; (ii) about 4.700-7.000 wt. % Glucopon 425; (iii) about 52.999-53.300 wt. % sodium sulfate; (iv) about 0.001-0.002 wt. % one or more dyes (total); and (vi) about 5.0000-7.0000 wt. % fragrance.

In some examples the self-adhesive material is an ultra-high viscosity gel, a solid, or a malleable solid. In certain of these embodiments, the composition of the material comprises an ethoxylated alcohol, an alkyl polyglycol ether, mineral oil, an alcohol, polyethylene glycol, an alkyl ether sulfate salt and water. In certain embodiments of these embodiments, the composition further includes an adhesion promoter, which may comprise one or more of an ethoxylated alcohol, an alkyl polyglycol ether, polyethylene glycol, and/or a hydrophilic polymer. In certain embodiments, the adhesion promoter is present from about 18 wt. % to about 80 wt. %. In various examples, the adhesion promoter causes a bond with water and gives the composition a dimensional stability under action of rinse water. In certain examples the composition is self-adhering to a hard surface upon application thereto and provides a wet film on said hard surface when water passes over said composition and hard surface. In various examples, the composition further comprises at least one additional nonionic surfactant and/or at least one active agent, wherein said active agent may be one or more of a fragrance, germicide, antimicrobial, bleach, or deodorizer. In certain examples the adhesion promoter is present in an amount of about 18 wt. % to about 27 wt. %. In various embodiments the mineral oil is present in an amount of greater than 0 to about 5 wt. %, and in others in an amount of about 0.5 wt. % to about 3.5 wt. %. In some examples the alcohol is present in an amount of greater than 0 to about 5 wt. %. In some examples, the polymer is present in an amount of about 1 wt. % to about 10 wt. %.

In one example, a method can include applying a self-adhesive material to a surface using a release material, allowing for the self-adhesive material to cure to the surface for a predetermined time period, and brushing the surface after the predetermined time period. The predetermined time period can be at least 24 hours, in one example. The self-adhesive material can be applied to the surface by pressing firmly along an entire border of the self-adhesive material. The release material may include a first half and a second half, and the first half and the second half can be configured to wrap around the self-adhesive material. Either the first half or the second half can be peeled off of the self-adhesive material to expose the self-adhesive material. The self-adhesive material can be substantially rectangular shaped. The release material can be a wax paper in one example. The shear force required to remove the self-adhesive material from the surface can increase after the predetermined time period. In particular, the shear force required to remove the self-adhesive material from the surface can increase after the predetermined time period in the range of 25% to 310%.

In another example, a cleaning apparatus can include a release material having a first half and a second half. The first half and the second half can be wrapped around a self-adhesive material and can be configured to release from the self-adhesive material after the self-adhesive material is applied to a surface. After the self-adhesive material is secured to the surface for a predetermined period, a shear force required to remove the product from the surface can increase. In one example, the packaging of the cleaning apparatus may include instructions indicating to a user to wait a predetermined time period prior to using the self-adhesive material as a manual cleaning agent. In one example, the predetermined time period prior to using the self-adhesive material as a manual cleaning agent can be approximately 24 hours. The instructions can further include an instruction to apply the self-adhesive material to the surface by pressing firmly along an entire border of the self-adhesive material. The instructions can further indicate to either pull the first half or the second half of the release material off of the self-adhesive material to expose the self-adhesive material. The self-adhesive material can be substantially rectangular shaped. The release material can be wax paper. A shear force required to remove the self-adhesive material from the surface can be increased after the predetermined time period. The shear force required to remove the self-adhesive material from the surface can increase after the predetermined time period in the range of 25% to 310%.

In one example, a method can include providing a self-adhesive material configured to continuously clean a surface by releasing cleaning or fragrance components when exposed to water. The self-adhesive material can define a first face and a second face, and the first face or the second face can be configured to adhere to the surface. The method may also include providing a release material, wrapping the release material around at least a portion of the self-adhesive material to form a wrapped self-adhesive material. The method can, in one example, also include providing instructions to a user to peel back a portion of the release material from one of the first face or the second face of the self-adhesive material to expose either the first face or the second face of the self-adhesive material, to apply the self-adhesive material to the surface by pressing the release material and the self-adhesive material against the surface, to allow the self-adhesive material to cure to the surface for a predetermined time period, and to use the self-adhesive material as a manual cleaning agent after the predetermined time period. The self-adhesive material can be marketed as both a continuous and manual cleaning agent.

In certain examples, the method may also include providing a release material with a first half and a second half, wrapping the first half and the second half of the release material around the self-adhesive material such that the first face of the self-adhesive material is covered by the first half of the release material and the second face of the self-adhesive is covered by the second half of the release material and providing instructions to peel back either the first half or the second half of the release material from one of the first face or the second face of the self-adhesive material to expose either the first face or the second face of the self-adhesive material, to apply the self-adhesive material to the surface by pressing one of the first half or the second half of the release material and the self-adhesive material against the surface. The surface can form part of a toilet bowl having a rim, and the instructions can indicate to the user to place the self-adhesive material below the rim and above a water line in the toilet bowl. The instructions can also indicate to the user to remove either the first half or the second half of the release material from the self-adhesive material after the self-adhesive material is applied to the surface. In one example, the self-adhesive material can be a cage-less toilet bowl cleaner. The self-adhesive material may define a perimeter, and the instructions can indicate to the user to press firmly along the entire perimeter of the self-adhesive material and can indicate that the predetermined time period is at least 24 hours. The self-adhesive material can be substantially rectangular shaped. The release material can be a wax paper, and a pouch can be provided for receiving the wrapped self-adhesive material in the pouch. A shear force required to remove the self-adhesive material from the surface may increase after the predetermined time period. In one example, the shear force required to remove the self-adhesive material from the surface can increase after the predetermined time period in the range of 25% to 310%.

In another example, a package can include a self-adhesive material that is configured to continuously clean a surface by releasing cleaning or fragrance components when exposed to water. The self-adhesive material can define a first face and a second face, and the first face or the second face can be configured to adhere to the surface. A release material may also be provided having a first half and a second half. The first half and the second half of the release material can be wrapped around the self-adhesive material such that the first face of the self-adhesive material is covered by the first half of the release material and the second face of the self-adhesive material is covered by the second half of the release material. The packaging may also include instructions to a user to peel back either the first half or the second half of the release material from one of the first face or the second face of the self-adhesive material to expose either the first face or the second face of the self-adhesive material, to apply the self-adhesive material to the surface by pressing one of the first half or the second half of the release material and the self-adhesive material against the surface, to allow the self-adhesive material to cure to the surface for a predetermined time period, and to use the self-adhesive material as a manual cleaning agent after the predetermined time period. The predetermined period can define a length of time that increases a shear force required to remove the product from the surface. The predetermined time period prior to using the self-adhesive material as a manual cleaning agent can be approximately 24 hours, in one example. In one example, the shear force after predetermined time period to remove the self-adhesive material from the surface can be greater than 1.5 lbs. The self-adhesive material can define a perimeter and the instructions can indicate to the user to press firmly along the entire perimeter of the self-adhesive material. The self-adhesive material can be substantially rectangular shaped. In one example, the shear force required to remove the self-adhesive material from the surface increases after the predetermined time period can be in the range of 25% to 310%.

In another example, a cleaning apparatus may include a self-adhesive material configured to continuously clean a surface by releasing cleaning or fragrance components when exposed to water. The self-adhesive material can define a first surface and a second surface, and the first surface or the second surface can be configured to adhere to the surface. A release material can include a first half and a second half, the first half and the second half of the release material can be wrapped around the self-adhesive material such that the first face of the self-adhesive material can be covered by the first half of the release material, and the second face of the self-adhesive material can be covered by the second half of the release material. In addition, one of the first half or the second half of the release material can be configured to peel away from the self-adhesive material to expose either the first surface or the second surface of the self-adhesive material, and the self-adhesive material can be configured to be applied the surface by pressing one of the first half or the second half of the release material and the self-adhesive material against the surface. The self-adhesive material can be configured to cure to the surface after predetermined time period to increase a shear force required to remove the product from the surface, and may be configured to become manual cleaning agent after the predetermined time period. The predetermined time period prior to using the self-adhesive material as a manual cleaning agent can, in one example, be approximately 24 hours. In one example, the shear force after predetermined time period to remove the self-adhesive material from the surface can be greater than 1.5 lbs. The self-adhesive material can be substantially rectangular shaped in one example. The shear force required to remove the self-adhesive material from the surface can increase after the predetermined time period in the range of 25% to 310%.

### INDUSTRIAL APPLICABILITY

The disclosure herein provides a cleaning apparatus and methods for using the cleaning apparatus. In certain examples, a self-adhesive material for cleaning a surface, an applicator for the self-adhesive material, a method of using the cleaning apparatus, applicator, and self-adhesive material, and instructing the user on a cleaning method are provided.

While certain examples and example configurations of the disclosure have been herein illustrated, shown and described, it is to be appreciated that various changes, rearrangements and modifications may be made therein, without departing from the scope of the disclosure. It is intended that the specific embodiments and configurations disclosed are illustrative of the best modes for practicing the disclosure, and should not be interpreted as limitations on the scope of the disclosure; it is to be appreciated that various changes, rearrangements and modifications may be made therein, without departing from the scope of the disclosure.

1. A package comprising:
a self-adhesive material configured to continuously clean a surface by releasing cleaning or fragrance components when exposed to water, the self-adhesive material defining a first face and a second face, the first face or the second face configured to adhere to the surface; and
a set of instructions that directs a user (1) to apply the self-adhesive material to the surface, to use the self-adhesive material as a continuous cleaning agent immediately after being applied, and (2) to use the self-adhesive material as a manual cleaning agent only after a predetermined time period, the predetermined period defining a length of time that increases a shear force required to remove the self-adhesive material from the surface.

2. The package of claim 1, wherein the predetermined time period prior to using the self-adhesive material as a manual cleaning agent is approximately 24 hours.

3. The package of claim 1, wherein the self-adhesive material defines a perimeter and the set of instructions indicate to the user to press firmly along the perimeter of the self-adhesive material when applying the self-adhesive material to the surface.

4. The package of claim 1, wherein the shear force required to remove the self-adhesive material from the surface increases after the predetermined time period in a range of 25% to 310%.

5. The package of claim 1, wherein the shear force after the predetermined time period to remove the self-adhesive material from the surface is greater than 1.5 lbs.

6. The package of claim 1, wherein the self-adhesive material is a toilet cleaner configured to be adhered to an inner surface of a toilet bowl and be scrubbed with a toilet bowl cleaning device while being used as a manual cleaning agent.

7. A method comprising:
providing a self-adhesive material configured to continuously treat a surface by releasing cleaning or fragrance components when exposed to water; and
providing a set of instructions that instructs a user (1) to apply the self-adhesive material to the surface, (2) to allow the self-adhesive material to cure to the surface for a predetermined time period, and (3) to use the self-adhesive material as a manual cleaning agent after the predetermined time period.

8. The method of claim 7, further comprising:
wrapping a release material around at least a portion of the self-adhesive material to form a wrapped self-adhesive material;
providing the release material with a first half and a second half, wrapping the first half and the second half of the release material around the self-adhesive material such that a first face of the self-adhesive material is covered by the first half of the release material and a second face of the self-adhesive is covered by the second half of the release material;
providing instructions to peel back either the first half or the second half of the release material from one of the first face or the second face of the self-adhesive material to expose either the first face or the second face of the self-adhesive material, to apply the self-adhesive material to the surface by pressing one of the first half or the second half of the release material and the self-adhesive material against the surface.

9. The method of claim 8, wherein the instructions indicate to the user to remove either the first half or the second half of the release material from the self-adhesive material after the self-adhesive material is applied to the surface.

10. The method of claim 7, further comprising marketing the self-adhesive material as both a continuous and manual cleaning agent.

11. The method of claim 7, wherein the surface forms part of a toilet bowl having a rim and wherein the set of instructions instruct the user to place the self-adhesive material below the rim and above a water line in the toilet bowl.

12. The method of claim 7, wherein the self-adhesive material is a cage-less toilet bowl cleaner.

13. The method of claim 7, wherein the self-adhesive material defines a perimeter and the set of instructions instruct the user to press firmly along the perimeter of the self-adhesive material.

14. The method of claim 7, wherein the set of instructions indicate that the predetermined time period is at least 24 hours.

15. The method of claim 7, wherein the self-adhesive material is substantially rectangular shaped.

16. The method of claim 7, wherein the release material is wax paper and further comprising providing a pouch for receiving the wrapped self-adhesive material.

17. The method of claim 7, wherein a shear force required to remove the self-adhesive material from the surface is increased after the predetermined time period.

18. The method of claim 17, wherein the shear force required to remove the self-adhesive material from the surface increases after the predetermined time period in a range of 25% to 310%.

19. A cleaning apparatus comprising:
a self-adhesive material configured to continuously treat a surface by releasing cleaning or fragrance components when exposed to water, the self-adhesive material defining a first face and a second face, the first face or the second face configured to adhere to the surface; and
a release material having a first half and a second half, the first half and the second half of the release material being wrapped around the self-adhesive material such that the first face of the self-adhesive material is covered by the first half of the release material and the second face of the self-adhesive material is covered by the second half of the release material;
wherein one of the first half or the second half of the release material is configured to peel away from the self-adhesive material to expose either the first face or the second face of the self-adhesive material and the self-adhesive material is configured to be applied to the surface by pressing the self-adhesive material against the surface,
wherein the self-adhesive material is configured to cure to the surface after a predetermined time period to increase a shear force required to remove the self-adhesive material from the surface, and is configured to remain adhered to the surface during use as a manual cleaning agent after the predetermined time period.

20. The cleaning apparatus of claim 19, wherein the shear force after predetermined time period to remove the self-adhesive material from the surface is greater than 1.5 lbs.

21. The cleaning apparatus of claim 19, wherein the predetermined time period prior to using the self-adhesive material as a manual cleaning agent is approximately 24 hours.

22. The cleaning apparatus of claim 19, wherein the self-adhesive material is substantially rectangular shaped.

23. The cleaning apparatus of claim 19, wherein the shear force required to remove the self-adhesive material from the surface increases after the predetermined time period in a range of 25% to 310%.
